(19) United States
(12) Patent Application Publication
(10) Pub. No.: US 2005/0227691 A1
(43) Pub. Date: Oct. 13, 2005

(54) Apparatus and method for handover between two networks during an ongoing communication

(76) Inventors: Mark E. Pecen, Palatine, IL (US); Sanjay Gupta, Lakewood, IL (US); Stephen L. Spear, Skokie, IL (US)

Correspondence Address: MOTOROLA INC, 600 NORTH US HIGHWAY 45, ROOM AS437, LIBERTYVILLE, IL, 60048-5343, US

(21) Appl. No.: 10/804,285

(22) Filed: Mar. 19, 2004

(51) Int. Cl. H04Q 7/20

(52) U.S. Cl. 455/435.2; 455/552.1; 455/436

(57) ABSTRACT

A method and apparatus for handover of a communication device between a first network and a second network while the communication device is in an ongoing communication. The communication device can register with the second network. The communication device can also enter an ongoing communication via the first network. The communication device can send a transfer request to the second network to request a handover of the ongoing communication between the first network and the second network without interrupting the ongoing communication.

### BACKGROUND

1. Field

The present disclosure is directed to a method and apparatus for handover of a communication device between a first network and a second network while the communication device is in an ongoing communication. More particularly, the present disclosure is directed to handover from a first network in which a communication device is in an ongoing communication to a second network that uses a different mode of communication from the first network.

2. Description of Related Art

Presently, mobile communication devices can travel between cells of a network on which the mobile communication device is operating. A mobile communication device can maintain an ongoing communication, such as a call, when traveling between cells of the same network by using handover between the cells. This handover can be done because both the current network and the mobile communication device have knowledge of the identities of the surrounding bases stations in adjacent cells that may be valid handover candidates within the current network. This knowledge is necessary because the mobile communication device must perform measurements on the radio-frequency signal received from the candidates, maintain synchronization to all the candidates, maintain a measurement database containing average measurements of such candidates, and send a measurement report to the current network. The current network uses the measurement report sent by the mobile to make an intelligent decision as to which base station would be the most acceptable candidate. For example, the current network can determine the identity of any appropriate handover candidates in the mobile communication device's current operating environment. The current network can then use a neighbor list to inform the mobile communication device of potential handover candidates.

Unfortunately, present networks do not allow handover of a mobile communication device to another network while the mobile communication device is in an ongoing communication. For example, an ongoing communication cannot be transferred from a cellular network to a wireless local area network. As another example, an ongoing communication cannot be transferred from a first radio access network to a second radio access network that is uncoordinated or has a different mode of communication with the first radio access network.

Thus, there is a need for handover from a first network in which a communication device is in an ongoing communication to a second network that uses a different mode of communication from the first network.

### BRIEF DESCRIPTION OF THE DRAWINGS

The embodiments of the present invention will be described with reference to the following figures, wherein like numerals designate like elements, and wherein:

FIG. 1 is an exemplary block diagram of a system according to one embodiment;

FIG. 2 is an exemplary block diagram of a communication device according to one embodiment;

FIG. 3 is an exemplary block diagram of a first network controller according to one embodiment;

FIG. 4 is an exemplary block diagram of a second network controller according to one embodiment;

FIG. 5 is an exemplary message diagram illustrating the operation of a system according to one embodiment; and

FIG. 6 is an exemplary message diagram illustrating the operation of a system according to another embodiment.

### DETAILED DESCRIPTION

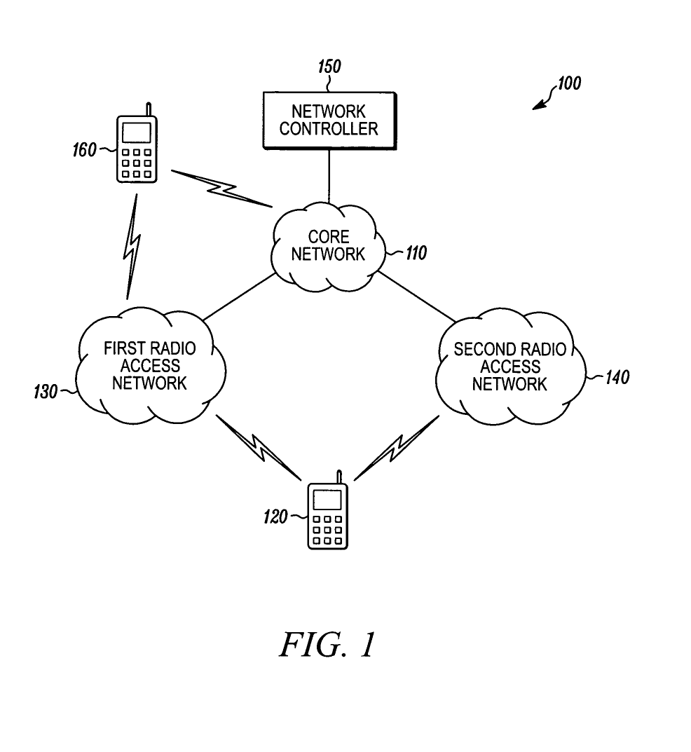

FIG. 1 is an exemplary block diagram of a system 100 according to one embodiment. The system 100 includes a network controller 150, a core network 110, a first radio access network 130, a second radio access network 140, and one or more terminals 120 and 160. The network controller 150 and/or other network controllers can be located at the core network 110, at the first radio access network 130, and/or at the second radio access network 140. Terminals 120 and 160 may include telephones, wireless telephones, cellular telephones, PDAs, pagers, personal computers, mobile communication devices, or any other device that is capable of sending and receiving communication signals on a network including wireless network. The networks may include any type of network that is capable of sending and receiving signals, such as wireless signals. For example, the networks may include a wireless telecommunications network, a cellular telephone network, a satellite communications network, a wireless local area network, and/or other like communications systems. Furthermore, the networks may include more than one network and may include a plurality of different types of networks. Thus, the networks may include a plurality of data networks, a plurality of telecommunications networks, a combination of data and telecommunications networks and other like communication systems capable of sending and receiving communication signals.

In operation, the terminal 120 can enter an ongoing communication with the terminal 160 via the first radio access network 130 and/or the core network 110. The terminal 120 can come within range of the second radio access network 140, which may overlap the first radio access network 130. The terminal 120 can transfer from the first radio access network 130 to the second radio access network 140 while maintaining the ongoing communication with the terminal 160.

For example, the terminal 120 can transfer to the second radio access network 140 while maintaining the ongoing communication with the terminal 160 by using a target-initiated method of handover by notifying the second radio access network 140, such as a wireless local area network, of a desire to transfer to the second radio access network 140. This concept can be the equivalent of having the second radio access network 140 inform the serving first radio access network 130 of its existence and identity, so that the serving first radio access network 130 is able to inform the core network 110, core network controller 150, serving support node, or the like where to transfer a data path upon handover. This target initiated approach can enable operators to add, remove and move base stations with little core network 110 and little signaling overhead generated.

For example, the terminal 120 may have previously authenticated and obtained an IP address from the second radio access network 140. The terminal 120, engaged in an ongoing communication, can determine that it is suitably connected to a base station of the second radio access network 140. Since the terminal 120 is already registered with the second radio access network 140 and is possession of a valid IP address, it can send a new NETWORK HANDOVER ANTICIPATED message to the second radio access network 140. This message can contain a cell-identifier and other information necessary for the second radio access network 140 to find the serving first radio access network 130 on a signaling plane. The second radio access network 140, in turn, can send a new NETWORK TARGET IDENTIFICATION message to the serving first radio access network 130, which now may consider the second radio access network 140 as a handover candidate. The second radio access network 140 may also send a new NETWORK TARGET IDENTIFICATION message to the core network 110 and/or controller 150 as well. The first radio access network 130 and network controller 150 can both send acknowledgements to the second radio access network 140 that they have received the target information. The first radio access network 130 can then send a HANDOVER REQUIRED message to the controller 150, and the remainder of the handover proceeds as normally for cells in a single network.

For example, to transfer the ongoing communication, the terminal 120 can send a Handover Anticipated message to a second technology base station controller for the second radio access network 140, which can in turn send a target base station controller identification message to a first technology base station controller for the first radio access network 130. The first technology base station controller can then send an acknowledgement message to the second technology base station controller. The second technology base station controller can then send a target identification message to a mobile switching center on the core network 110, which in turn acknowledges this message to the second technology base station controller. The second technology base station controller can then send a target acknowledgement message to the first technology base station controller. The first technology base station controller can then send the mobile switching center a handover required message. The mobile switching center can respond by sending the second technology base station controller a handover request message, which is acknowledged by the second technology base station controller. Once the mobile switching center receives acknowledgement that the second technology base station controller has received the handover request, the mobile switching center can send a handover command to the first technology base station controller. The first technology base station controller can send, to the terminal 120, a handover message which informs the mobile terminal on what radio resources to operate on the second radio access network 140 and at what point in time to begin operation on the new radio resources in the domain of the second radio access network 140. Upon successful entry into the second radio access network 140, the terminal 120 can send the mobile switching center a handover complete message. The mobile switching center can in turn send the first technology radio base station controller a handover succeeded message, indicating to the first technology base station controller that it may release it allocated radio resources for subsequent use by another terminal.

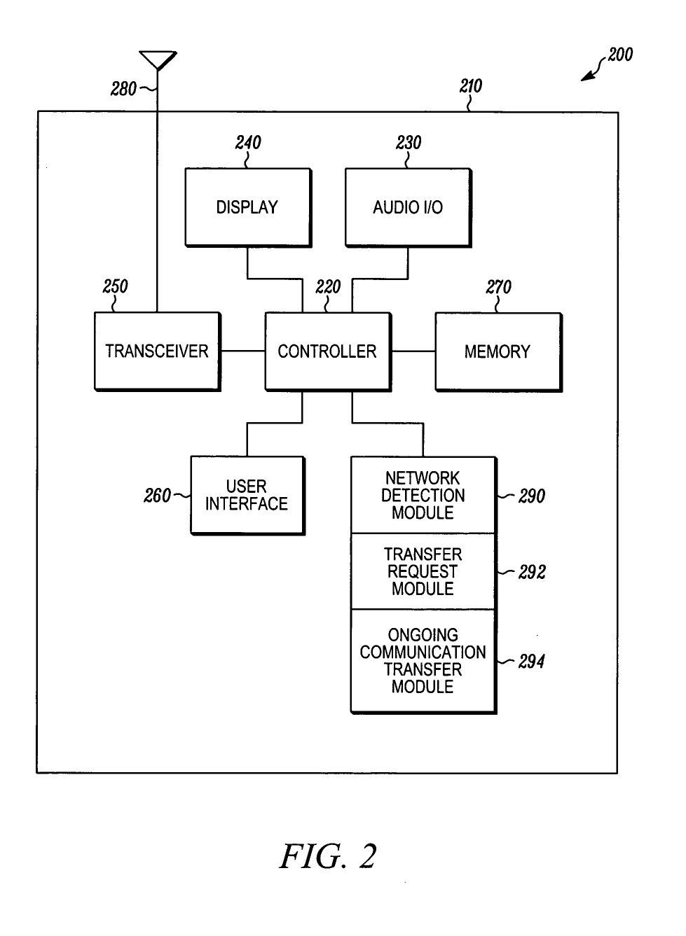

FIG. 2 is an exemplary block diagram of a communication device 200, such as the terminal 120 or the terminal 160, according to one embodiment. The communication device 200 can include a housing 210, a controller 220 coupled to the housing 210, audio input and output circuitry 230 coupled to the housing 210, a display 240 coupled to the housing 210, a transceiver 250 coupled to the housing 210, a user interface 260 coupled to the housing 210, a memory 270 coupled to the housing 210, and an antenna 280 coupled to the housing 210 and the transceiver 250. The display 240 can be a liquid crystal display (LCD), a light emitting diode (LED) display, a plasma display, or any other means for displaying information. The transceiver 250 may include a transmitter and/or a receiver. The audio input and output circuitry 230 can include a microphone, a speaker, a transducer, or any other audio input and output circuitry. The user interface 260 can include a keypad, buttons, a touch pad, a joystick, an additional display, or any other device useful for providing an interface between a user and an electronic device. The memory 270 may include a random access memory, a read only memory, an optical memory, a subscriber identity module memory, or any other memory that can be coupled to a communication device.

The communication device 200 can be used for handover from a first radio access network 130 to a second radio access network 140, the first radio access network 130 using a different mode of communication from the second radio access network 140. Accordingly, the controller 220 can be configured to enter an ongoing communication on the first radio access network 130. The communication device 200 can also include a network detection module 290 coupled to the controller 220, the network detection module 290 configured to detect the presence of a second radio access network 140, the second radio access network 140 being uncoordinated with the first radio access network 130 in that neither the first radio access network 130 nor the second radio access network 140 being able to exert control over each other. The communication device 200 can also include a transfer request module 292 coupled to the controller 220, the transfer request module 292 configured to send a transfer request to the second radio access network 140 requesting transfer of the ongoing communication from the first radio access network 130 to the second radio access network 140. The communication device 200 can also include an ongoing communication transfer module 294 coupled to the controller 220 the ongoing communication transfer module 294 configured to transfer the ongoing communication from the first radio access network 130 to the second radio access network 140. The first radio access network 130 can be a cellular radio access network and the second radio access network 140 can be a wireless local area network. The second radio access network 140 may not be associated with the first radio access network 130 by the first radio access network 130 not initially having information on the second radio access network 140. The controller 220 may further be configured to register the communication device 200 on the second radio access network 140 and transmit information from the communication device 200 to the second radio access network 140 indicating the communication device 200 is actively in an ongoing communication on the first radio access network 130. The communication device controller 220 can be further configured to perform additional steps of the messaging diagrams illustrated below. Additionally, the network detection module 290, the transfer request module 292, and the ongoing communication transfer module 294 may be software or hardware modules and may be autonomous, may be located on the controller 220, or may be located in the memory 270.

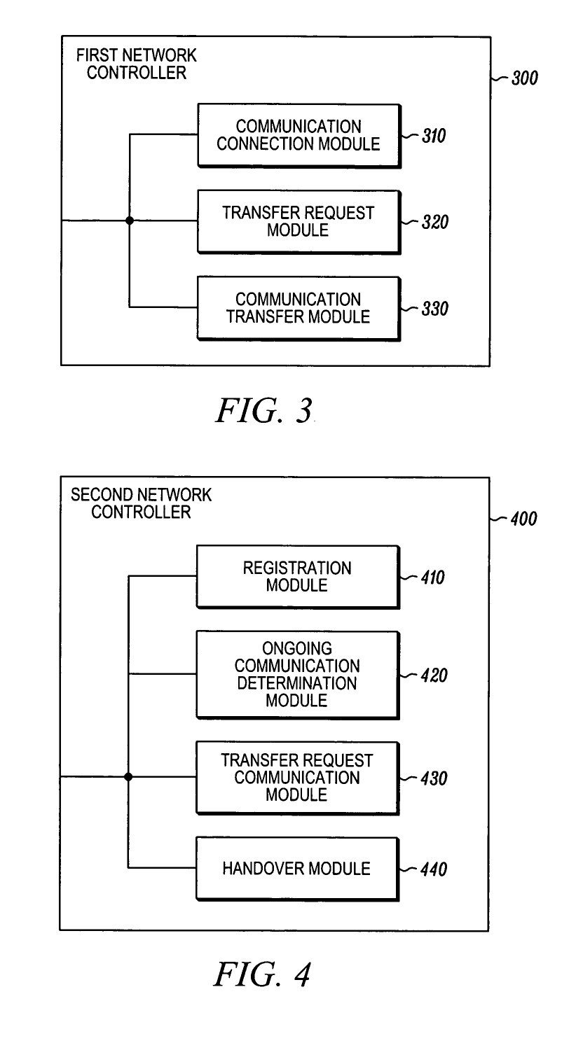

FIG. 3 is an exemplary block diagram of a first network controller 300, such as the network controller 150, located at the first radio access network 130, according to one embodiment. The first network controller 300 can be in the first radio access network 130 for handover from the first radio access network 130 to the second radio access network 140, the first radio access network 130 using a different mode of communication from the second radio access network 140. The first network controller 300 can include a communication connection module 310 configured to establish an ongoing communication with the communication device 200 on the first radio access network 130, a transfer request module 320 configured to receive a transfer request from the second radio access network 140 to the first radio access network 130 requesting transfer of the ongoing communication from the first radio access network 130 to the second radio access network 140, and a communication transfer module 330 configured to transfer the ongoing communication from the first radio access network 130 to the second radio access network 140. The second radio access network 140 can be a wireless local area network and the first radio access network 130 can be a cellular radio access network. The ongoing communication can be a data session or a call. The transfer request can include a handover request message including a destination identifier of the second radio access network 140. The ongoing communication can be a connection between the communication device 200 and a connected party, such as the terminal 160. The first network controller 300 can be further configured to perform additional steps of the messaging diagrams illustrated below. Additionally, the communication connection module 310, the transfer request module 320, and/or the communication transfer module 330 may be software or hardware modules and may be autonomous or combined on the first network controller 300.

FIG. 4 is an exemplary block diagram of a second network controller 400, such as the network controller 150, located at the second radio access network 140, according to one embodiment. The second network controller 400 can be used for handover from a first radio access network 130 to a second radio access network 140, the first radio access network 130 using a different mode of communication from the second radio access network 140. The second network controller 400 can include a registration module 410 configured to register a communication device 200 on the second radio access network 140, an ongoing communication determination module 420 configured to receive information at the second radio access network 140 from the communication device 200 indicating the communication device 200 is actively in an ongoing communication on the first radio access network 130, a transfer request communication module 430 configured to send a transfer request from the second radio access network 140 to the first radio access network 130 requesting transfer of the ongoing communication from the first radio access network 130 to the second radio access network 140, and a handover module 440 configured to transfer the ongoing communication from the first radio access network 130 to the second radio access network 140. The registration module 410 can be further configured to receive a communication at the second radio access network 140 from the communication device 200, the communication indicating a desire to transfer the ongoing communication from the first radio access network 130 to the second radio access network 140. The transfer request communication module 430 can be further configured to send a transfer request including a handover request message including a destination identifier of the second radio access network 140. The second network controller 400 can be further configured to perform additional steps of the messaging diagrams illustrated below. Additionally, the registration module 410, the ongoing communication determination module 420, the transfer request communication module 430, and/or the handover module 440 may be software or hardware modules and may be autonomous or combined on the second network controller 400.

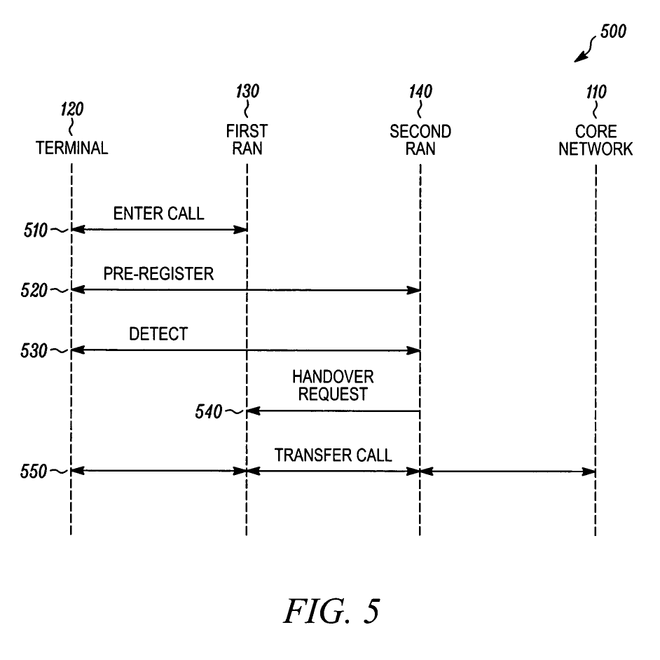

FIG. 5 is an exemplary message diagram 500 illustrating the operation of the system 100 according to one embodiment. For example, the message diagram 500 illustrates the operation of a method in the terminal 120 for handover from a first radio access network 130 to a second radio access network 140, the first radio access network 130 using a different mode of communication from the second radio access network 140. The message diagram 500 can include entering 510 an ongoing communication on the first radio access network 130, detecting 530 the presence of a second radio access network 140, the second radio access network 140 being uncoordinated with the first radio access network 130 and/or neither the first radio access network 130 nor the second radio access network 140 being able to exert control over each other. Detecting 530 can include sending a transfer request from the terminal 120 to the second radio access network 140 requesting transfer of the ongoing communication from the first radio access network 130 to the second radio access network 140. The second radio access network 140 can send a handover request 540 to the first radio access network 130. The message diagram 500 can also include transferring 550 the ongoing communication from the first radio access network 130 to the second radio access network 140. The terminal 120 may also register 520 with the second radio access network 140 before or after entering 510 the call. Additionally, registering can involve subscribing to service with a network, a network operator, or a service provider. Also, detecting the presence of a network can involve detecting a signal from the network and establishing a presence with the network.

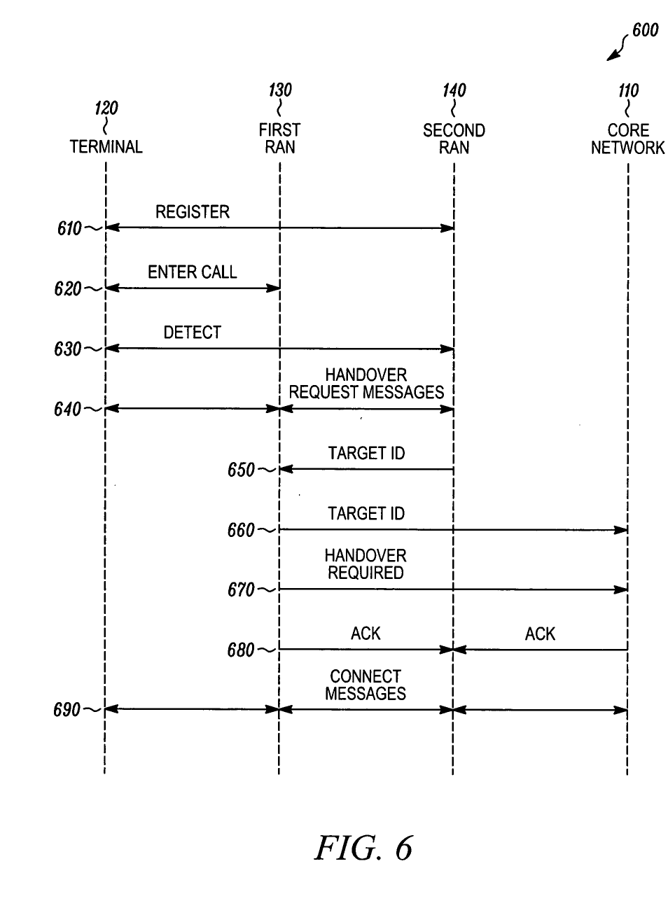

FIG. 6 is an exemplary message diagram 600 illustrating the operation of the system 100 according to another embodiment. For example, the message diagram 600 illustrates the operation of a method in the terminal 120 for handover from a first radio access network 130 to a second radio access network 140, the first radio access network 130 using a different mode of communication from the second radio access network 140. The method can include registering 610 a terminal 120 on the second radio access network 140, receiving 630 or 640 information at the second radio access network 140 from the terminal 120 indicating the terminal 120 is actively in an ongoing communication 620 on the first radio access network 130, sending 640 a transfer request from the second radio access network 140 to the first radio access network 130 or from the terminal 120 to the second radio access network 140 requesting transfer of the ongoing communication from the first radio access network 130 to the second radio access network 140, and transferring 690 the ongoing communication from the first radio access network 130 to the second radio access network 140.

The ongoing communication can be a data session, a call, or both. The method can also include receiving 640 a communication at the second radio access network 140 from the terminal 120, the communication indicating a desire to transfer the ongoing communication from the first radio access network 130 to the second radio access network 140. The method can also include sending 640, to the terminal 120, an acknowledgement of reception of the communication from the terminal 120 at the second radio access network 140. Sending a transfer request can include sending a handover request message including a destination identifier of the second radio access network 140. The ongoing communication can be a connection between the terminal 120 and a connected party 160. Transferring the ongoing communication from the first radio access network 130 to the second radio access network 140 can include switching the connection between the terminal 120 and the connected party 160 via the first radio access network to a connection between the terminal 120 and the connected party 160 via the second radio access network. The method can also include receiving 610 a registration request from a terminal 120 at the second radio access network 140. The registration request 610 may be sent after an ongoing communication 620 is established or at any date or time before the ongoing communication 620 is established. The second radio access network 140 can be a wireless local area network and the first radio access network 130 can be a cellular radio access network. The second radio access network 140 can be a cellular radio access network and the first radio access network 130 can be a wireless local area network. The first radio access network 130 and/or the second radio access network 140 can be at least one of an 802.11 network, a Bluetooth network, a global system for mobile communication network, a universal mobile telecommunications service network, a code division multiple access network, a time division multiple access network, an analog wireless communication network, a proprietary wireless network, and/or an 802.16 network. The method can also include recognizing 690 transfer of the terminal 120 to the second radio access network 140 based on the terminal 120 appearing on the second radio access network 140 at an appointed frequency and at an appointed time, and sending 690 a handover completion message from the second radio access network 140 to the first radio access network 130.

Transferring the ongoing communication from the first radio access network 130 to the second radio access network 140 can include connecting the ongoing communication between the second radio access network 140 and a connected party 160 via an internet protocol network. Transferring the ongoing communication from the first radio access network 130 to the second radio access network 140 can also include connecting the ongoing communication between the second radio access network 140 and a connected party 160 via a circuit network. Transferring the ongoing communication from the first radio access network 130 to the second radio access network 140 can also include connecting the ongoing communication between the second radio access network 140 and a connected party 160 via a network portion of the first radio access network 130 and a radio portion of the second radio access network 140. Transferring the ongoing communication from the first radio access network 130 to the second radio access network radio access can also include bypassing the first radio access network 130.

According to another embodiment, the message diagram 600 illustrates a method in the first radio access network 130 for handover from the first radio access network 130 to the second radio access network 140, the first radio access network 130 using a different mode of communication from the second radio access network 140. The method can include establishing 620 an ongoing communication with the terminal 120 on the first radio access network 130, receiving 640 a transfer request from the second radio access network 140 to the first radio access network 130 requesting transfer of the ongoing communication from the first radio access network 130 to the second radio access network 140, and transferring 690 the ongoing communication from the first radio access network 130 to the second radio access network 140. The second radio access network 130 can be a wireless local area network and the first radio access network 140 can be a cellular radio access network. The ongoing communication can be a data session, a call, or both. Receiving a transfer request can include receiving a handover request message including a destination identifier of the second radio access network 140. The ongoing communication can be a connection between the terminal 120 and a connected party 160. Transferring the ongoing communication from the first radio access network 130 to the second radio access network 140 can include switching the connection between the terminal 120 and the connected party 160 via the first radio access network 130 to a connection between the terminal 120 and the connected party 160 via the second radio access network 140. The second radio access network 140 and the first radio access network 130 can be at least one of a wireless local area network and a cellular radio access network. The method can also include receiving 690 a handover completion message at the first radio access network 130 from the second radio access network 140. Transferring the ongoing communication from the first radio access network 130 to the second radio access network 140 can also include connecting the ongoing communication between the second radio access network 140 and a connected party 160 via at least one of an internet protocol network and a circuit network. Transferring the ongoing communication from the first radio access network 130 to the second radio access network 140 can also include connecting the ongoing communication between the second radio access network 140 and a connected party 160 via a network portion of the first radio access network 130 and a radio portion of the second radio access network 140. Transferring the ongoing communication from the first radio access network 130 to the second radio access network 140 can also include bypassing the first radio access network 130.

Additional messages may be sent for the handover procedure. For example, a target identifier identifying the second radio access network 140 can be sent 650 from the second radio access network 140 to the first radio access network 130. The target identifier can be forwarded 660 from the first radio access network 130 to the core network 110. The first radio access network 130 can also send 670 a handover required message to the core network 110. Both the first radio access network 130 and the core network 110 can send 680 an acknowledgement message to the second radio access network 140 to acknowledge the handover request. The terminal 120 can then be transferred 690 to the second radio access network 140.

The method of this invention is preferably implemented on a programmed processor. However, controller 220 may also be implemented on a general purpose or special purpose computer, a programmed microprocessor or microcontroller and peripheral integrated circuit elements, an ASIC or other integrated circuit, a hardware electronic or logic circuit such as a discrete element circuit, a programmable logic device such as a PLD, PLA, FPGA or PAL, or the like. In general, any device on which resides a finite state machine capable of implementing the flowcharts shown in the Figures may be used to implement the processor functions of this invention.

While this invention has been described with specific embodiments thereof, it is evident that many alternatives, modifications, and variations will be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the invention by simply employing the elements of the independent claims. Accordingly, the preferred embodiments of the invention as set forth herein are intended to be illustrative, not limiting. Various changes may be made without departing from the spirit and scope of the invention.

1. A method in a communication device for handover from a first radio access network to a second radio access network, the first radio access network using a different mode of communication from the second radio access network, the method comprising:
entering an ongoing communication on the first radio access network;
detecting the presence of a second radio access network, the second radio access network being uncoordinated with the first radio access network;
sending a transfer request to the second radio access network requesting transfer of the ongoing communication from the first radio access network to the second radio access network; and
transferring the ongoing communication from the first radio access network to the second radio access network.

2. The method according to claim 1, wherein the first radio access network is a cellular radio access network and wherein the second radio access network is a wireless local area network.

3. The method according to claim 1, wherein the second radio access network is not associated with the first radio access network by the first radio access network not initially having information on the second radio access network.

4. The method according to claim 1, further comprising:
registering the communication device on the second radio access network; and
transmitting information from the communication device to the second radio access network indicating the communication device is actively in an ongoing communication on the first radio access network.

5. A method in a radio access network for handover from a first radio access network to a second radio access network, the first radio access network using a different mode of communication from the second radio access network, the method comprising:
registering a communication device on the second radio access network;
receiving information at the second radio access network from the communication device indicating the communication device is actively in an ongoing communication on the first radio access network;
sending a transfer request from the second radio access network to the first radio access network requesting transfer of the ongoing communication from the first radio access network to the second radio access network; and
transferring the ongoing communication from the first radio access network to the second radio access network.

6. The method according to claim 5, wherein the ongoing communication comprises one of a data session and a call.

7. The method according to claim 5, further comprising receiving a communication at the second radio access network from the communication device, the communication indicating a desire to transfer the ongoing communication from the first radio access network to the second radio access network.

8. The method according to claim 7, further comprising sending, to the communication device, an acknowledgement of reception of the communication from the communication device at the second radio access network.

9. The method according to claim 5, wherein sending a transfer request includes sending a handover request message including a destination identifier of the second radio access network.

10. The method according to claim 5, wherein the ongoing communication comprises a connection between the communication device and a connected party.

11. The method according to claim 10, wherein transferring the ongoing communication from the first radio access network to the second radio access network comprises switching the connection between the communication device and the connected party via the first radio access network to a connection between the communication device and the connected party via the second radio access network.

12. The method according to claim 5, further comprising receiving a registration request from a communication device at the second radio access network.

13. The method according to claim 5, wherein the second radio access network comprises a wireless local area network and the first radio access network comprises a cellular radio access network.

14. The method according to claim 5, wherein the second radio access network comprises a cellular radio access network and the first radio access network comprises a wireless local area network.

15. The method according to claim 5, wherein at least one of the first radio access network and the second first radio access network comprises at least one of an 802.11 network, a Bluetooth network, a global system for mobile communication network, a universal mobile telecommunications service network, a code division multiple access network, a time division multiple access network, an analog wireless communication network, a proprietary wireless network, and an 802.16 network.

16. The method according to claim 5, further comprising:
recognizing transfer of the communication device to the second radio access network based on the communication device appearing on the second radio access network at an appointed frequency and at an appointed time; and
sending a handover completion message from the second radio access network to the first radio access network.

17. The method according to claim 5, wherein transferring the ongoing communication from the first radio access network to the second radio access network further comprises connecting the ongoing communication between the second radio access network and a connected party via an internet protocol network.

18. The method according to claim 5, wherein transferring the ongoing communication from the first radio access network to the second radio access network further comprises connecting the ongoing communication between the second radio access network and a connected party via a circuit network.

19. The method according to claim 5, wherein transferring the ongoing communication from the first radio access network to the second radio access network further comprises connecting the ongoing communication between the second radio access network and a connected party via a network portion of the first radio access network and a radio portion of the second radio access network.

20. The method according to claim 5, wherein transferring the ongoing communication from the first radio access network to the second radio access network further comprises bypassing the first radio access network.

21. A method in a radio access network for handover from a first radio access network to a second radio access network, the first radio access network using a different mode of communication from the second radio access network, the method comprising:
establishing an ongoing communication with the communication device on the first radio access network;
receiving a transfer request from the second radio access network to the first radio access network requesting transfer of the ongoing communication from the first radio access network to the second radio access network; and
transferring the ongoing communication from the first radio access network to the second radio access network.

22. The method according to claim 21, wherein the second radio access network comprises a wireless local area network and the first radio access network comprises a cellular radio access network, and
wherein the ongoing communication comprises at least one of a data session and a call.

23. The method according to claim 21, wherein receiving a transfer request includes receiving a handover request message including a destination identifier of the second radio access network.

24. The method according to claim 21, wherein the ongoing communication comprises a connection between the communication device and a connected party.

25. The method according to claim 24, wherein transferring the ongoing communication from the first radio access network to the second radio access network comprises switching the connection between the communication device and the connected party via the first radio access network to a connection between the communication device and the connected party via the second radio access network.

26. The method according to claim 21, wherein the second radio access network and the first radio access network comprise at least one of a wireless local area network and a cellular radio access network.

27. The method according to claim 21, further comprising receiving a handover completion message at the first radio access network from the second radio access network.

28. The method according to claim 21, wherein transferring the ongoing communication from the first radio access network to the second radio access network further comprises connecting the ongoing communication between the second radio access network and a connected party via at least one of an internet protocol network and a circuit network.

29. The method according to claim 21, wherein transferring the ongoing communication from the first radio access network to the second radio access network further comprises connecting the ongoing communication between the second radio access network and a connected party via a network portion of the first radio access network and a radio portion of the second radio access network.

30. The method according to claim 21, wherein transferring the ongoing communication from the first radio access network to the second radio access network further comprises bypassing the first radio access network.

31. A communication device for handover from a first radio access network to a second radio access network, the first radio access network using a different mode of communication from the second radio access network, the communication device comprising:
a transceiver;
a controller coupled to the transceiver, the controller configured to enter an ongoing communication on the first radio access network;
a network detection module coupled to the controller, the network detection module configured to detect the presence of a second radio access network, the second radio access network being uncoordinated with the first radio access network;
a transfer request module coupled to the controller, the transfer request module configured to send a transfer request to the second radio access network requesting transfer of the ongoing communication from the first radio access network to the second radio access network; and
an ongoing communication transfer module coupled to the controller the ongoing communication transfer module configured to transfer the ongoing communication from the first radio access network to the second radio access network.

32. The communication device according to claim 31, wherein the first radio access network is a cellular radio access network and wherein the second radio access network is a wireless local area network.

33. The communication device according to claim 31, wherein the second radio access network is not associated with the first radio access network by the first radio access network not initially having information on the second radio access network.

34. The communication device according to claim 31, wherein the controller is further configured to register the communication device on the second radio access network and transmit information from the communication device to the second radio access network indicating the communication device is actively in an ongoing communication on the first radio access network.

35. A controller in a radio access network for handover from a first radio access network to a second radio access network, the first radio access network using a different mode of communication from the second radio access network, the controller comprising:
a registration module configured to register a communication device on the second radio access network;
an ongoing communication determination module configured to receive information at the second radio access network from the communication device indicating the communication device is actively in an ongoing communication on the first radio access network;
a transfer request communication module configured to send a transfer request from the second radio access network to the first radio access network requesting transfer of the ongoing communication from the first radio access network to the second radio access network; and
a handover module configured to transfer the ongoing communication from the first radio access network to the second radio access network.

36. The controller according to claim 35, wherein the registration module is further configured to receive a communication at the second radio access network from the communication device, the communication indicating a desire to transfer the ongoing communication from the first radio access network to the second radio access network.

37. The controller according to claim 35, wherein the transfer request communication module is further configured to send a transfer request including a handover request message including a destination identifier of the second radio access network.

38. A controller in a radio access network for handover from a first radio access network to a second radio access network, the first radio access network using a different mode of communication from the second radio access network, the controller comprising:
a communication connection module configured to establish an ongoing communication with the communication device on the first radio access network;
a transfer request module configured to receive a transfer request from the second radio access network to the first radio access network requesting transfer of the ongoing communication from the first radio access network to the second radio access network; and
a communication transfer module configured to transfer the ongoing communication from the first radio access network to the second radio access network.

39. The controller according to claim 38, wherein the second radio access network comprises a wireless local area network and the first radio access network comprises a cellular radio access network, and
wherein the ongoing communication comprises one of a data session and a call.

40. The controller according to claim 38, wherein the transfer request includes a handover request message including a destination identifier of the second radio access network.

41. The controller according to claim 38, wherein the ongoing communication comprises a connection between the communication device and a connected party.
